(19) United States
(12) Patent Application Publication
(10) Pub. No.: US 2011/0079361 A1
(43) Pub. Date: Apr. 7, 2011

(54) APPARATUS FOR SEMICONDUCTOR DIE BONDING

(76) Inventors: Byeong-kuk Park, Cheonan-si (KR); Seok Goh, Cheonan-si (KR); Kyoung-bok Cho, Cheonan-si (KR); Dong-soo Lee, Cheonan-si (KR); Jung-hwan Woo, Cheonan-si (KR)

(21) Appl. No.: 12/850,027

(22) Filed: Aug. 4, 2010

(30) Foreign Application Priority Data
Oct. 7, 2009 (KR) 10-2009-0095174

(51) Int. Cl. B32B 37/02

(52) U.S. Cl. 156/541; 156/556

(57) ABSTRACT

An apparatus for semiconductor die bonding includes a first bonding head and a second bonding head configured to respectively pickup a first semiconductor chip and a second semiconductor chip located at a pickup point. The apparatus for semiconductor die bonding may also include a first transfer device configured to transfer the first bonding head from the pickup point to a bonding point located on a substrate along a transfer path. The first transfer device may further be configured to return to the pickup point along a first return path after the first semiconductor chip is bonded to the substrate. Also, the apparatus for semiconductor die bonding may include a second transfer device configured to transfer the second bonding head from the pickup point to the bonding point located on the substrate along the transfer path. The second transfer device may further be configured to return to the pickup point along a second return path after the second semiconductor chip is bonded to the substrate. Additionally, the apparatus for semiconductor die bonding may include a controller configured to alternately apply a transfer signal and a return signal to the first transfer device and the second transfer device so the first bonding head and the second bonding head do not collide with each other.

### CROSS-REFERENCE TO RELATED APPLICATIONS

This non-provisional U.S. application claims priority under 35 U.S.C. §119 to Korean Patent Application No. 10-2009-0095174, filed on Oct. 7, 2009, in the Korean Intellectual Property Office, the disclosure of which is incorporated herein in its entirety by reference.

### BACKGROUND

Inventive concepts relate to apparatuses for semiconductor die bonding. More particularly, embodiments relate to an apparatus for semiconductor die bonding which has improved economical efficiency and productivity by using a plurality of bonding heads for bonding a plurality of semiconductor chips to one substrate.

A conventional semiconductor assembling process includes a back grounding process, a sawing process, a die attaching process, and a wire bonding process in order to make a semiconductor thin and small. In the back grounding process, the backside of a wafer is ground. In the sawing process, the ground wafer is separated into chips by using diamond blade. In the die attaching process, a semiconductor chip that is separated into chips is bonded to a lead frame or a PCB substrate, and in the wire bonding process, a chip pad of the semiconductor chip is connected to the lead frame using a wire.

When a conventional die bonding apparatus is used in the die attaching process, a series of processes is repeatedly performed. A bonding head (or a picker) moves down in order to pickup pieces of semiconductor chips from a wafer. If, the semiconductor chips are picked up, the bonding head moves up, the bonding head moves to a bonding position. Then, the bonding head moves down for next bonding, bonding is performed, and the bonding head returns to the wafer for next bonding.

In the case of such a general die bonding apparatus, the time required for each process is added together so as to establish a cycle time of a system.

In order to reduce the cycle time, each process may be shortened in order to improve or increase productivity. However, there are limits in the time required for each process.

In addition, a plurality of die bonding apparatuses may be further installed in order to improve or increase productivity. However, the cost for installing the system increases in proportion to the number of installed die bonding apparatuses so that economical efficiency may be significantly decreased.

### SUMMARY

Example embodiments provide an apparatus for semiconductor die bonding. The apparatus having improved productivity by reducing a cycle time of a system using two bonding heads that alternately bond semiconductor chips picked up by a wafer, a picker, or a die shuttle to one substrate, thereby having improved economical efficiency by preventing further installation of other apparatuses.

Example embodiments of the inventive concepts may also provide an apparatus for semiconductor die bonding whereby semiconductor chips may be die-bonded in various ways including direct bonding or reverse bonding by using a picker flip device or a die shuttle.

According to example embodiments of the inventive concepts, an apparatus for semiconductor die bonding includes a first bonding head and a second bonding head configured to respectively pickup a first semiconductor chip and a second semiconductor chip located at a pickup point.

The apparatus for semiconductor die bonding may also include a first transfer device configured to transfer the first bonding head from the pickup point to a bonding point located on a substrate along a transfer path. The first transfer device may further be configured to return to the pickup point along a first return path after the first semiconductor chip is bonded to the substrate.

Also, example embodiments of the apparatus for semiconductor die bonding may include a second transfer device configured to transfer the second bonding head from the pickup point to the bonding point located on the substrate along the transfer path. The second transfer device may further be configured to return to the pickup point along a second return path after the second semiconductor chip is bonded to the substrate.

Additionally, the apparatus for semiconductor die bonding may include a controller configured to alternately apply a transfer signal and a return signal to the first transfer device and the second transfer device so the first bonding head and the second bonding head do not collide with each other. The first transfer device may be a first robot arm configured to move the first bonding head along an X-axis direction, Y-axis direction, or a Z-axis direction, and angularly rotates the first bonding head. The second transfer device may be a robot arm configured to move the second bonding head along the X-axis direction, the Y-axis direction, or the Z-axis direction, and angularly rotates the second bonding head.

The first return path of the first transfer device may be a circuit in a first direction from the bonding point to the pickup point and the second return path of the second transfer device may be a circuit in a second direction from the bonding point to the pickup point, wherein the first direction and the second direction are opposite directions.

Example embodiments of the apparatus may further include a chip picker configured to pick up a third semiconductor chip from a picking point of a wafer fixed to a wafer table. The chip picker may further be configured to transfer the third semiconductor chip to the pickup point in order to transfer the third semiconductor chip to the first bonding head or the second bonding head.

The apparatus may further include a picker flip device configured to rotate the chip picker to turn over the third semiconductor chip picked up by the chip picker.

Also, example embodiments of the apparatus may further include a die shuttle configured to transfer the third semiconductor chip transferred from the chip picker to the pickup point in order to transfer the third semiconductor chip to the first bonding head or the second bonding head

Example embodiments may further include a shuttle transfer device configured to transfer the die shuttle.

In Example embodiments the controller may be configured to apply the return signal to the second transfer device while applying the transfer signal to the first transfer device. The controller may also be configured to apply the return signal to the first transfer device while applying the transfer signal to the second transfer device so the first bonding head and the second bonding head do not interfere with each other.

In example embodiments the first return path of the first transfer device and the second return path of the second transfer device may include a circuit where the direction of the first and second return paths change at least once.

In further example embodiments the first return path of the first transfer device may be a circuit that progresses from the bonding point in a first direction from the transfer path. The first return path may then progress to a reverse direction of the transfer path, and the first return path may then progress toward the pickup point. In example embodiments the second return path of the second transfer device may be a circuit that progresses from the bonding point in a second direction from the bonding point in a second direction from the transfer path The second return path may then progress to the reverse direction of the transfer path, and progress toward the pickup point. According to at least some example embodiments, the bonding point of the first bonding head and the bonding point of the second bonding head may be located within the substrate.

According to example embodiments, a die bonding apparatus may include first and second bonding heads configured to respectively pickup first and second semiconductor chips at a first location.

In Example embodiments, the die bonding apparatus may include first and second transfer devices may be configured to respectively transfer the first and the second bonding heads to a second location along a transfer path, and the first and second transfer devices configured to return to the first point along respective first and second return paths.

According to at least some example embodiments, the die bonding apparatus may include a processor configured to alternatively apply first and second signals to the first transfer device and the processor configured to alternatively apply the second and the first signal to the second transfer device so the first and second bonding heads do not collide with each other.

### BRIEF DESCRIPTION OF THE DRAWINGS

Example embodiments of inventive concepts will be more clearly understood from the following detailed description taken in conjunction with the accompanying drawings in which:

FIG. 1 is a perspective view of an apparatus for semiconductor die bonding according to an embodiment of inventive concepts;

FIG. 2 is a plan view showing a state where a first bonding head of the apparatus for semiconductor die bonding of FIG. 1 returns to its original position along a first return path and a second bonding head moves along a transfer path, according to an embodiment of inventive concepts;

FIG. 3 is a plan view showing a state where a first bonding head of the apparatus for semiconductor die bonding of FIG. 1 moves along a transfer path and a second bonding head returns to its original position along a second return path, according to an embodiment of inventive concepts;

FIG. 4 is a perspective view of a chip picker of the apparatus for semiconductor die bonding of FIG. 1 according to another embodiment of inventive concepts;

FIG. 5 is a perspective view of a die shuttle of the apparatus for semiconductor die bonding of FIG. 1 according to another embodiment of inventive concepts;

FIG. 6 is a plan view showing a state where a first bonding head of the apparatus for semiconductor die bonding of FIG. 1 returns to its original position along a first return path and a second bonding head moves along a transfer path, according to another embodiment of inventive concepts;

FIG. 7 is a plan view showing a state where a first bonding head of the apparatus for semiconductor die bonding of FIG. 1 moves along a transfer path and a second bonding head returns to its original position along a second return path, according to another embodiment of inventive concepts; and

FIG. 8 is a perspective view of an apparatus for semiconductor die bonding according to another embodiment of inventive concepts.

### DETAILED DESCRIPTION OF THE EMBODIMENTS

Various example embodiments will be described more fully hereinafter with reference to the accompanying drawings, in which some example embodiments are shown. Inventive concepts may, however, be embodied in many different forms and should not be construed as limited to the example embodiments set forth herein. Rather, these example embodiments are provided so that this disclosure will be thorough and complete, and will fully convey the scope of inventive concepts to those skilled in the art. In the drawings, the sizes and relative sizes of elements may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of inventive concepts. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of inventive concepts. As used herein, the singular forms “a,” “an” and “the” are intended to include the plural forms as well, unless the context clearly indicates otherwise. It will be further understood that the terms “comprises”, “comprising”, “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

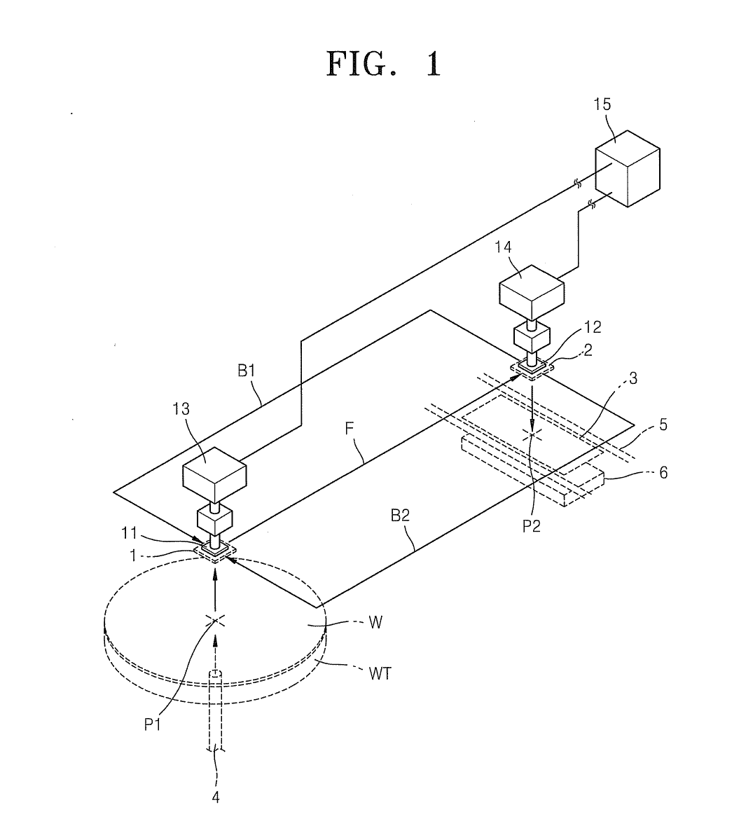

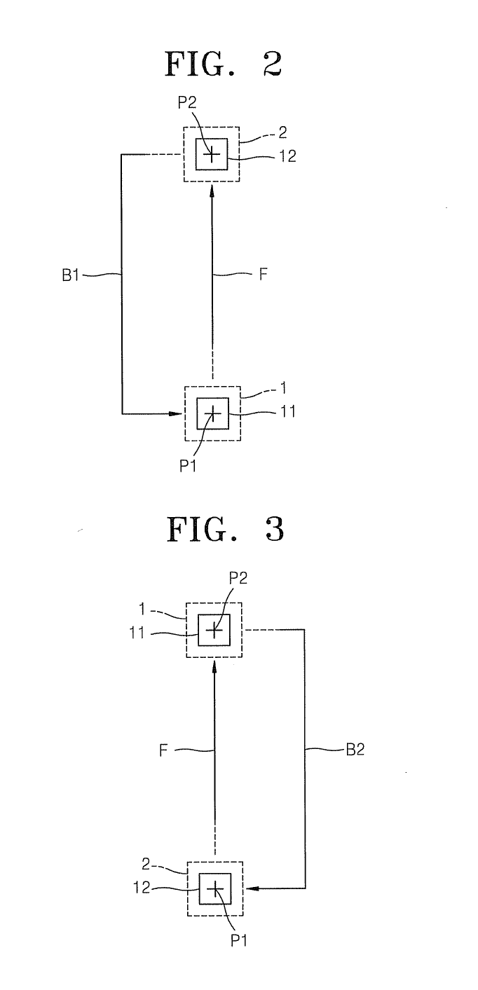

FIG. 1 is a perspective view of an apparatus for semiconductor die bonding according to an embodiment of the inventive concept. FIG. 1 shows an operational state of the apparatus for semiconductor die bonding of, FIG. 2 is a plan view showing a state where a first bonding head of the apparatus for semiconductor die bonding of FIG. 1 returns to its original position along a first return path and a second bonding head moves along a transfer path. FIG. 3 is a plan view showing a state where a first bonding head of the apparatus for semiconductor die bonding of FIG. 1 moves along a transfer path and a second bonding head returns to its original position along a second return path, according to an embodiment of inventive concepts.

As illustrated in FIGS. 1 through 3, the apparatus for semiconductor die bonding according to the present embodiment of inventive concepts includes at least two bonding heads 11 and 12 that bond a plurality of semiconductor chips 1 and 2 to a substrate 3. In more detail, the apparatus for semiconductor die bonding includes a first bonding head 11, a first transfer device 13, a second bonding head 12, a second transfer device 14, and a controller 15.

The first bonding head 11 lifts or picks up a first semiconductor chip 1 positioned at a pickup point P1, transfers, relocates or moves the picked first semiconductor chip 1 to a bonding point P2 on the substrate 3 along a transfer path F. The first bonding head 11 then returns to the pickup point P1 along a first return path B1 after the first semiconductor chip 1 is bonded to the substrate 3.

As illustrated in FIGS. 1 and 2, the first return path B1 of the first bonding head 11 may be a left-side circulation path in a left direction (one direction) in relation to the transfer path F so that the first bonding head 11 and the second bonding head 12 do not collide or interfere with each other. Alternatively, the first return path could be a right-side circulation path in a right direction in relation to the transfer path F.

Also, the first transfer device 13 is a robot arm that moves the first bonding head 11 along an X-axis direction, Y-axis direction, or a Z-axis direction, and angularly rotates the first bonding head 11. Such a robot arm includes an X-axis transfer actuator, a Y-axis transfer actuator, a Z-axis transfer actuator, and a rotation motor by which motion in various directions is possible. Thus, various robot arms that may arrange the semiconductor chip at an accurate position may be used.

The second bonding head 12 picks up a second semiconductor chip 2 positioned at the pickup point P1, moves the picked second semiconductor chip 2 to the bonding point P2 on the substrate 3 along the transfer path F. The second bonding head 12 then returns to the pickup point P1 along a second return path B2 after the second semiconductor chip 2 is bonded to the substrate 3.

As illustrated in FIGS. 1 and 3, the second return path B2 of the second bonding head 12 may be a right-side circulation path in a right direction (the other direction) in relation to the transfer path F so that the first bonding head 11 and the second bonding head 12 do not collide or interfere with each other. Alternatively, if the first return path is a right-side circulation path, the second return path could be in a left-side circulation path.

Also, the second transfer device 14 is a robot arm that moves the second bonding head 12 along an X-axis direction, Y-axis direction, or a Z-axis direction, and angularly rotates the second bonding head 12. Such a robot arm includes an X-axis transfer actuator, a Y-axis transfer actuator, a Z-axis transfer actuator, and a rotation motor by which motion in various directions is possible. Thus, various robot arms that may arrange the semiconductor chip at an accurate position may be used.

As illustrated in FIG. 1, the controller 15 alternately applies a transfer signal and a return signal to the first transfer device 13 and the second transfer device 14 so the first bonding head 11 and the second bonding head 12 do not interfere or collide with each other. When the controller 15 applies a transfer signal to the first transfer device 13 for the first bonding head 11 the controller 15 may apply a return signal to the second transfer device 15 so the bonding head 11 and the second bonding head 12 do not collide or interfere with each other. Alternatively, when the controller 15 applies a transfer signal to the second transfer device 14, the controller 15 may apply a return signal to the first transfer device 13, so the first transfer device 13 and the second transfer device 14 do not interfere or collide with each other.

Accordingly, as illustrated in FIGS. 2 and 3, the first return path B1 of the first bonding head 11 and the second return path B2 of the second bonding head 12 are controller or determined according to a control or processor of the controller 15. Thus, the apparatus for semiconductor die bonding may include a return path B1 or B2 which are parallel to the transfer path F.

More specifically, the first return path B1 of the first bonding head 11 and the second return path B2 of the second bonding head 12 are described more fully as follows. As illustrated in FIG. 2, the first return path B1 of the first bonding head 11 progresses from the bonding point P2 to a left-side direction of the transfer path F in a left-side direction of the transfer path F forming a bent straight line, parallel to the transfer path F, progresses to a reverse direction of the transfer path F, and progresses toward the pickup point P1.

As illustrated in FIG. 3, the second return path B2 of the second bonding head 12 progresses from the bonding point P2 to a right-side direction of the transfer path F in a right-side direction of the transfer path F forming a bent straight line, parallel to the transfer path F, progresses to a reverse direction of the transfer path F, and progresses toward the pickup point P1.

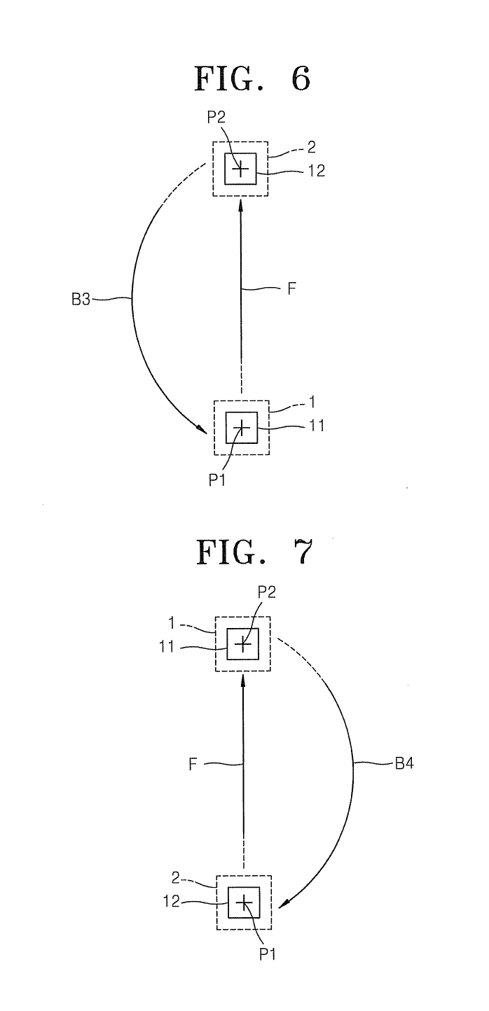

As illustrated in FIGS. 6 and 7, a first return path B3 of the first bonding head 11 and a second return path B4 of the second bonding head 12 may include a curved line path. Additionally, the first return path B3 and the second return path B4 may be located on opposite sides of the transfer path F.

That is, as illustrated in FIG. 6, the first return path B3 of the first bonding head 11 may progress from the bonding point P2 toward the pickup point P1 on a left-side direction of the transfer path F forming a left-side semicircular arc so as to move in a left-side direction of the transfer path F forming a curved line. Alternatively, the first return path B3 of the first bonding head may progress from the bonding point P2 toward the pickup point P1 on a right side direction of the transfer path F.

As illustrated in FIG. 7, the second return path B4 of the second bonding head 12 may progress from the bonding point P2 toward the pickup point P1 on a right-side direction of the transfer path F forming a right-side semicircular arc so as to move in a right-side direction of the transfer path F forming a curved line. Alternatively, the second return path B4 of the first bonding head may progress from the bonding point P2 toward the pickup point P1 on a right side direction of the transfer path F.

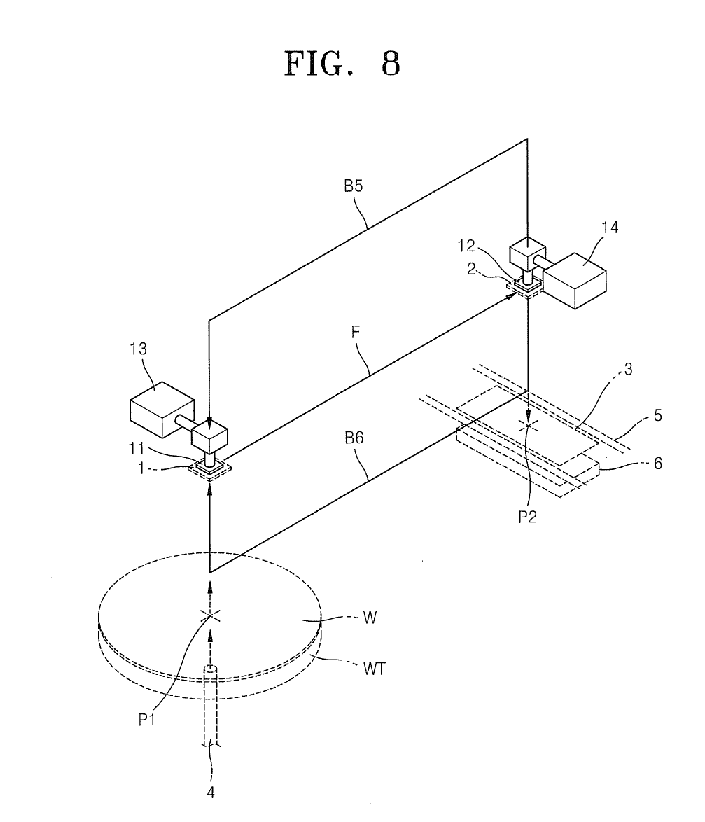

The first return path B3 of the first bonding head 11 and the second return path B4 of the second bonding head 12 may vary within a range that the first return path B3 of the first bonding head 11 and the second return path B4 of the second bonding head 12 do not interfere or collide with each other. Thus, as illustrated in FIG. 8, a first return path B5 of the first bonding head 11 is a top-side circulation path up to the top of the transfer path F and a second return path B6 of the second bonding head 12 may be a bottom-side circulation path up to the bottom of the transfer path F. Alternatively, a first return path B5 of the first bonding head 11 could be a bottom-side circulation path up to the top of the transfer path F and a second return path B6 of the second bonding head 12 may be a top-side circulation path up to the bottom of the transfer path F.

Referring back to FIG. 1, in the apparatus for semiconductor die bonding, the first bonding head 11 or the second bonding head 12 lifts or directly picks up the semiconductor chips located on a wafer W from the pickup point P1 of the wafer W fixed to a wafer table WT, wherein the semiconductor chips are separated from an adhesive tape by being pressed by an eject hood 4 from the wafer W on the wafer table WT that is partially or completely cut. The semiconductor chips are then transferred or moved to the bonding point P2 along the transfer path F, and bonded to the substrate 3. The first bonding head 11 returns to the pickup point P1 along the first return path B1, or the second bonding head 12 returns to the pickup point P1 along the second return path B2.

Here, the transfer path F may be a straight line path that connects the upper part of the pickup point P1 with the upper part of the bonding point P2. The bonding point P2 of the first bonding head 11 and the second bonding head 12 may be located within the substrate 3.

Also, an index rail 5 that guides the substrate 3 to the bonding point P2 is disposed or installed at the bonding point P2. Also, a heater plate 6 that applies pressure and heat so as for the first and second semiconductor chips 1 and 2 transferred to the bonding point P2 to be attached to the substrate 3 may be disposed or installed below the index rail.

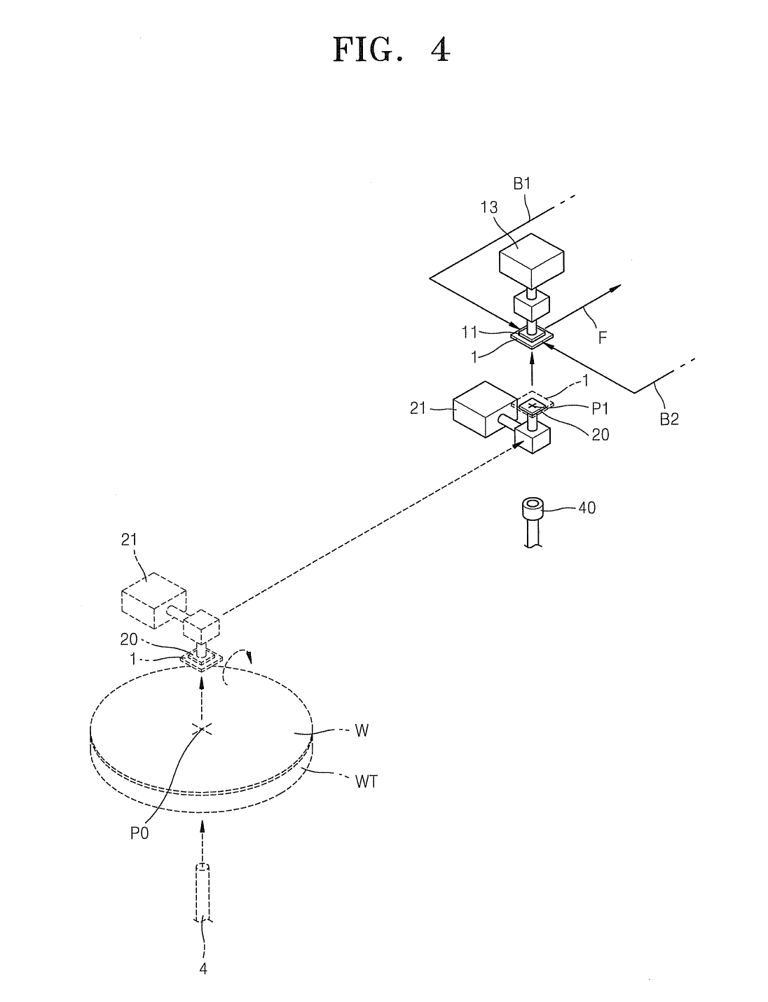

FIG. 4 is a perspective view of a chip picker 20 of the apparatus for semiconductor die bonding of FIG. 1, according to another embodiment of the inventive concept. FIG. 4 shows an operational state of the chip picker 20.

In FIG. 1, the first bonding head 11 or the second bonding head 12 lifts or directly picks up the semiconductor chips from the pickup point P1 of the wafer W fixed to the wafer table WT. However, in FIG. 4, the chip picker 20 may be further disposed or installed in the apparatus for semiconductor die bonding, wherein the chip picker 20 lifts or picks up the first semiconductor chip 1 from a picking point P0 of the wafer W fixed to the wafer table WT. The chip picker 20 then may move or transfer the first semiconductor chip 1 to the pickup point P1 in order to transfer the first semiconductor chip 1 to the first bonding head 11 or the second bonding head 12.

In addition, a picker flip device 21 may be further disposed or installed in the apparatus for semiconductor die bonding. The picker flip device 21 turns over or rotates the chip picker 20 so as to turn over the first semiconductor chip picked up by the chip picker 20 so that the first semiconductor chip 1 may be bonded to the substrate 3 in a reversed state.

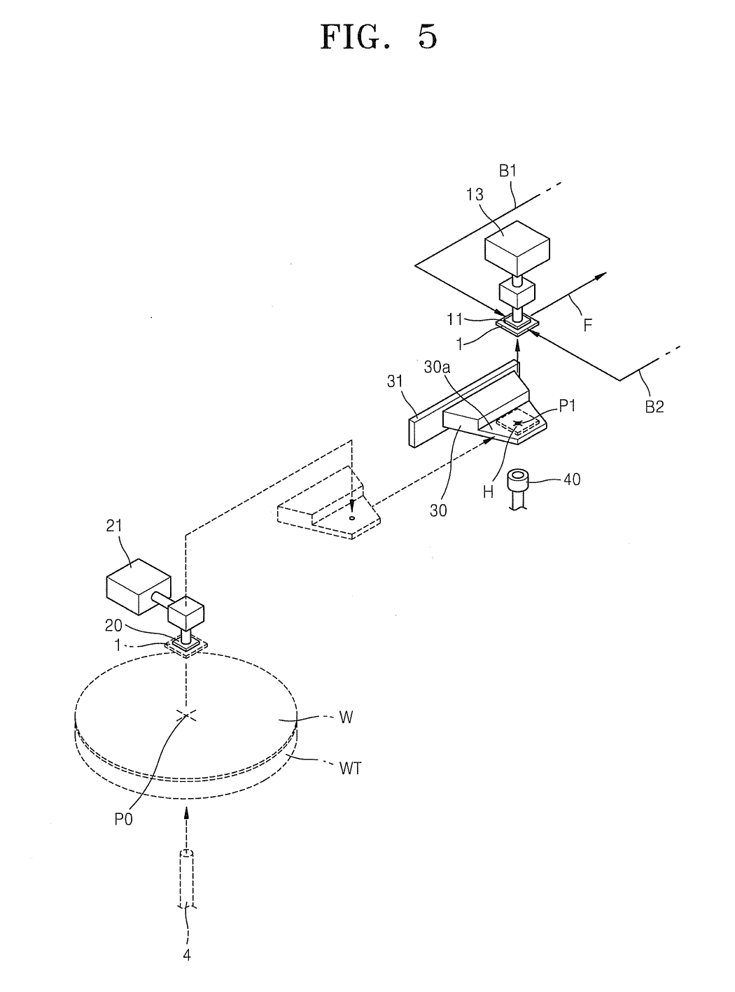

FIG. 5 is a perspective view of a die shuttle 30 of the apparatus for semiconductor die bonding apparatus of FIG. 1, according to another embodiment of inventive concepts. FIG. 5 shows an operational state of the die shuttle 30.

The die shuttle 30 and a shuttle transfer device 31 may be further disposed installed in the apparatus for semiconductor die bonding. The die shuttle 30 moves or transfers the first semiconductor chip 1 received from the chip picker 20 to the pickup point P1 in order to move or transfer the first semiconductor chip 1 to the first bonding head 11 or the second bonding head 12. The shuttle transfer device 31 moves the die shuttle 30, and thus the first semiconductor chip 1 may be bonded to the substrate 3 in a reversed state as illustrated in FIG. 4. Also, the semiconductor chip 1 may be directly bonded to the substrate 3 as illustrated in FIG. 5 so that a system may be widely used.

A vacuum hole H may be formed in a seating surface 30a of the die shuttle 30 on which the first semiconductor chip 1 is seated. The vacuum, hole H may be formed so that the die shuttle 30 vacuum-adsorbs the first semiconductor chip 1 during transfer of the first semiconductor chip 1 so that the first semiconductor chip 1 may be securely transferred.

A under vision device 40 for viewing or observing the first semiconductor chip 1 lifted or picked up by the first bonding head 11 or the second bonding head 12 may be disposed or installed below the pickup point P1. Thus, the under vision device 40 may be used to arrange the position of or examine the first semiconductor chip 1.

A die bonding process of the apparatus for semiconductor die bonding according to the present embodiment of inventive concepts is as follows. If the first semiconductor chip is to be bonded to the substrate 3 in a reversed state, the chip picker 20 lifts or picks up the first semiconductor chip 1 from the picking point P0 of the wafer W fixed to the wafer table WT The picker flip device 21 rotates or turns over the chip picker 20 so as to rotate or turn over the first semiconductor chip 1 lifted or picked up by the chip picker 20. The first semiconductor chip 1 that is turned over is transferred to the pickup point P1 of the first bonding head 11, as illustrated in FIG. 4. Then, the first bonding head 11 lifts or picks up the first semiconductor chip 1, bonds the first semiconductor chip 1 to the substrate 3 along the transfer path F, and returns to the pickup point P1 along the first return path B1.

When the first bonding head 11 picks up the first semiconductor chip 1 and the chip picker 20 returns to the picking point P0 of the wafer W, the under vision device 40 is used to determine the state of the first semiconductor chip 1 picked up by the first bonding head 11. The under vision device 40 is also used to arrange the first semiconductor chip 1 so that the first semiconductor chip 1 may be transferred to an accurate position.

Although not illustrated, the next semiconductor chip 2 may be transferred by the second bonding head 12 along the transfer path F and the second bonding head 12 may return along the second return path B2.

If the first semiconductor chip is to be directly bonded to the substrate 3, the chip picker 20 picks up the first semiconductor chip 1 from the picking point P0 of the wafer W fixed to the wafer table WT and places the picked first semiconductor chip 1 on the die shuttle 30 as illustrated in FIG. 5. Then, the die shuttle 30 vacuum-adsorbs the first semiconductor chip 1 and directly transfers the first semiconductor chip 1 to the pickup point P1 of the first bonding head 11. The first bonding head 11 picks up the first semiconductor chip 1, bonds the picked first semiconductor chip 1 to the substrate 3 of FIG. 1 along the transfer path F, and returns along the first return path B1. Although not illustrated, the next semiconductor chip is transferred by the second bonding head 12 along the transfer path F and the second bonding head 12 may return along the second return path B2.

Thus, when the semiconductor die bonding apparatus according to inventive concepts is used, the first semiconductor chip 1 may be die bonded to the substrate 3 in a reversed state or directly bonded to the substrate 3 so that a system may be widely used and various semiconductor assembling processes may be performed.

As described above, in the apparatus for semiconductor die bonding according to inventive concepts, when one bonding head transfers a semiconductor chip, another bonding head returns to transfer another semiconductor chip. Thus, the time required for one chip is limited or reduced so that productivity is significantly increased, economical efficiency is improved by limiting, reducing or preventing further installation of unnecessary apparatuses, and various die bonding is possible.

While inventive concepts have been particularly shown and described with reference to exemplary embodiments thereof, it will be understood that various changes in form and details may be made therein without departing from the spirit and scope of the following claims.

What is claimed is:

1. An apparatus for semiconductor die bonding, the apparatus comprising:
a first bonding head and a second bonding head configured to respectively pickup a first semiconductor chip and a second semiconductor chip located at a pickup point;
a first transfer device configured to transfer the first bonding head from the pickup point to a bonding point located on a substrate along a transfer path, the first transfer device further configured to return to the pickup point along a first return path after the first semiconductor chip is bonded to the substrate;
a second transfer device configured to transfer the second bonding head from the pickup point to the bonding point located on the substrate along the transfer path, the second transfer device further configured to return to the pickup point along a second return path after the second semiconductor chip is bonded to the substrate;
a controller configured to alternately apply a transfer signal and a return signal to the first transfer device and the second transfer device so the first bonding head and the second bonding head do not collide with each other.

2. The apparatus of claim 1, wherein the first transfer device is a first robot arm configured to move the first bonding head along at least one of an X-axis direction, Y-axis direction, and a Z-axis direction, and the first transfer device is further configured to angularly rotate the first bonding head, and the second transfer device is a second robot arm configured to move the second bonding head along at least one of the X-axis direction, the Y-axis direction, and the Z-axis direction, and the second transfer device is further configured to angularly rotate the second bonding head.

3. The apparatus of claim 1, wherein the first return path of the first transfer device is a circuit in a first direction from the bonding point to the pickup point and the second return path of the second transfer device is a circuit in a second direction from the bonding point to the pickup point, wherein the first direction and second direction are opposite directions.

4. The apparatus of claim 1, wherein the first return path of the first transfer device is a top-side circuit above the transfer path from the bonding point to the pickup point and the second return path of the second transfer device is a bottom-side circuit below the transfer path from the bonding point to the pickup point.

5. The apparatus of claim 1, further comprising:
a vision device disposed below the pickup point, wherein the vision device is configured to observe the first and the second semiconductor chips.

6. The apparatus of claim 1, further comprising:
a chip picker configured to pickup a third semiconductor chip from a first point of a wafer fixed to a wafer table and the chip picker further configured to transfer the third semiconductor chip to the pickup point in order to transfer the third semiconductor chip to the first bonding head or the second bonding head; and
a picker flip device configured to rotate the chip picker to turn over the third semiconductor chip picked up by the chip picker.

7. The apparatus of claim 6, further comprising:
a die shuttle configured to transfer the third semiconductor chip transferred from the chip picker to the pickup point in order to transfer the third semiconductor chip to the first bonding head or the second bonding head; and
a shuttle transfer device configured to transfer the die shuttle.

8. The apparatus of claim 7, wherein a vacuum hole is formed in a seating surface of the die shuttle on which the third semiconductor chip is disposed.

9. The apparatus of claim 1, wherein the controller is configured to apply the return signal to the second transfer device while applying the transfer signal to the first transfer device and the controller is further configured to apply the return signal to the first transfer device while applying the transfer signal to the second transfer device so the first bonding head and the second bonding head do not to interfere with each other.

10. The apparatus of claim 1, wherein the first return path of the first transfer device and the second return path of the second transfer device are parallel to the transfer path.

11. The apparatus of claim 1, wherein the first return path of the first transfer device is a circuit that progresses from the bonding point in a first direction from the transfer path, the first return path progresses in a reverse direction of the transfer path, and the first return path progresses toward the pickup point, and the second return path of the second transfer device is a circuit that progresses from the bonding point in a second direction from the transfer path, the second return path progresses in the reverse direction of the transfer path, and the second return path progresses toward the pickup point, wherein the first direction and second direction are opposites.

12. The apparatus of claim 1, wherein the first return path of the first transfer device and the second return path of the second transfer device include a curved line path.

13. The apparatus of claim 1, further comprising:
an index rail configured to guide the substrate to the bonding point.

14. The apparatus of claim 13, further comprising:
a heater plate, located below the index rail, configured to apply pressure and heat so at least one of the first and the second semiconductor chips transferred to the bonding point is attached to the substrate.

15. The apparatus of claim 1, wherein the transfer path is a straight line path between the pickup point and the bonding point.

16. The apparatus of claim 1, wherein the first and the second semiconductor chips are separated from an adhesive tape by being pressed by an eject hood from the wafer on the wafer table that is partially or completely cut.

17. The apparatus of claim 1, wherein the bonding point of the first bonding head and the bonding point of the second bonding head are located within the substrate.

18. An apparatus for semiconductor die bonding, the apparatus comprising:
a first and a second bonding head configured to respectively pickup a first and a second semiconductor chip located at a pickup point,
a first transfer device configured to transfer the first bonding head from the pickup point to a bonding point located on a substrate along a transfer path, the first transfer device further configured to return to the pickup point along a first circuit in a first direction from the bonding point to the pickup point;
a second transfer device configured to transfer the second bonding head from the pickup point to the bonding point located on the substrate along the transfer path, the second transfer device further configured to return to the pickup point along a first circuit in a second direction from the bonding point to the pickup point;
a controller configured to alternately apply a transfer signal and a return signal to the first transfer device and the second transfer device so that the first bonding head and the second bonding head do not interfere with each other;
a chip picker configured to pickup a third semiconductor chip from a picking point of a wafer fixed to a wafer table and the chip picker configured to transfer the third semiconductor chip to the pickup point to hand over the third semiconductor chip to the first bonding head or the second bonding head; and
a picker flip device configured to rotate the chip picker to rotate the third semiconductor chip picked up by the chip picker.

19. A die bonding apparatus comprising:
first and second bonding heads configured to respectively pickup first and second semiconductor chips at a first location;
first and second transfer devices configured to respectively transfer the first and the second bonding heads to a second location along a transfer path, and the first and second transfer devices configured to return to the first point along respective first and second return paths; and
a processor configured to alternatively apply first and second signals to the first transfer device and the processor configured to alternatively apply the second and the first signal to the second transfer device so the first and second bonding heads do not collide with each other.

20. The die bonding apparatus of claim 19, wherein the first return path is a first-side circuit parallel to the transfer path and the second return path is a second-side circuit parallel to the transfer path.
